(19) United States
(12) Patent Application Publication
(10) Pub. No.: US 2008/0121631 A1
(43) Pub. Date: May 29, 2008

(54) Smoke heating oven

(76) Inventor: Ching-Hsiang Wang, Tainan City (TW)

Correspondence Address: Ching-Hsiang Wang, 235 Chung - Ho, Box 8-24, Taipei, omitted

(21) Appl. No.: 11/724,778

(22) Filed: Mar. 12, 2007

Related U.S. Application Data
(63) Continuation-in-part of application No. 11/604,381, filed on Nov. 27, 2006, now abandoned.

(51) Int. Cl. A21B 1/00

(52) U.S. Cl. 219/393

(57) ABSTRACT

A smoke and electric heating oven comprises an oven body installed with a receiving chamber; a receiving frame being installed therein, a supporting frame being installed below the receiving frame; the supporting frame being installed with a heating tube; an outer side of the oven body being enclosed by heating stripes; a top of the oven body being protruded with a chimney which penetrates to the receiving chamber; a front side of the oven body being installed with a door; a front edge of the oven body having a control panel; a heating box installed on the supporting frame in the oven body; the heating tube being inserted into the heating box; and a casing enclosing an outer side of the oven body and heating stripes; a top of the casing having a pass hole; the chimney passing through the pass hole.

The present invention is a continuation in part (CIP) of U.S. patent application with Ser. No. 11/604,381 which is invented and assigned to the inventor and applicant of the present invention, and thus the contents of U.S. patent application Ser. No. 11/604,381 is incorporated into the present invention as a part of the present invention.

### FIELD OF THE INVENTION

The present invention relates to ovens, and particularly to a smoke and electric heating oven, which has the function of electric heating and smoke heating by woods. Another object of the present invention is to provide a smoke and electric heating oven, wherein the baked object is baked uniformly.

### BACKGROUND OF THE INVENTION

A prior art oven Al is illustrated in FIG. 1. A bottom or interior of the oven is installed with electric heating device A11 (maybe a fan is also added). The baked object is placed in a baking disk A10. A door A12 is closed. Electric generated heat is transferred into the oven for baking foods. However in the prior art oven A1, heat is radiated to the baked object directly so that the baking effect is not preferred. For example the heating is not uniform due to the distances of the different parts of the baked object to the heat source. As a result, it is possible that one side of the baked object is cooked and another side has not been cooked or the exterior of the baked object is cooked, while another part has not been cooked. Thus, in baking process, the door of the oven is often to be opened for turning the baked object.

Moreover, in the prior art oven, when the door of oven is often opened and closed. The door in the prior art design is not preferred and thus as for a long time, gaps are generated between the door and the front side of the oven. Thus the heat in the oven will drain out.

Furthermore, in the prior art oven, it has only the function of baking, but no function of smoking is provided. Thus if it is desired to heat an object by smoke, the object must be placed to a heating furnace. Thus is inconvenient for users.

### SUMMARY OF THE INVENTION

Accordingly, the primary object of the present invention is to provide a smoke and electric heating oven, which has the function of electric heating and smoke heating by woods.

Another object of the present invention is to provide a smoke and electric heating oven, wherein the baked object is baked uniformly.

Another object of the present invention is to provide a smoke and electric heating oven, wherein a door of the oven body can be tightly sealed to prevent the drainage of smoke and vapor.

A further object of the present invention is to provide a smoke and electric heating oven, wherein a receiving frame can be detached easily for cleaning.

A yet object of the present invention is to provide a smoke and electric heating oven, wherein a water box is provided for receiving condensing water. The water box can be detached easily and conveniently for washing.

A still object of the present invention is to provide a smoke and electric heating oven, wherein the draining of smoke is controllable by adjusting an opening of a chimney.

To achieve above objects, the present invention provides a smoke and electric heating oven which comprises an oven body installed with a receiving chamber; a receiving frame being installed therein, a supporting frame being installed below the receiving frame; the supporting frame being installed with a heating tube; an outer side of the oven body being enclosed by heating stripes; a top of the oven body being protruded with a chimney which penetrates to the receiving chamber; a front side of the oven body being installed with a door; a front edge of the oven body having a control panel; a heating box installed on the supporting frame in the oven body; the heating tube being inserted into the heating box; and a casing enclosing an outer side of the oven body and heating stripes; a top of the casing having a pass hole; the chimney passing through the pass hole.

The various objects and advantages of the present invention will be more readily understood from the following detailed description when read in conjunction with the appended drawing.

### BRIEF DESCRIPTION OF THE DRAWINGS

FIG. 1 shows a prior art oven.

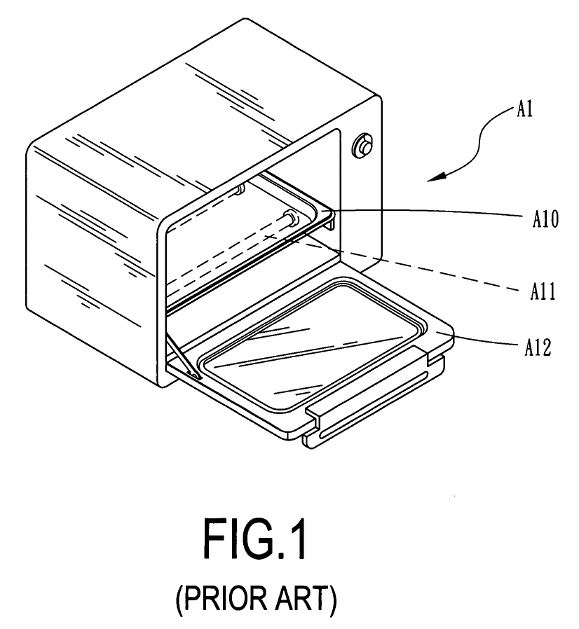

FIG. 2 is an exploded perspective view of the present invention.

FIG. 3 is a perspective view showing the oven body of the present invention which is viewed from another orientation.

FIG. 4 is a partial exploded perspective view of the present invention.

FIG. 5 is a schematic view showing that the water box is drawn out.

FIG. 6 is an assembled schematic view about the drain proof stripe of the present invention.

FIG. 7 is an enlarged view of part A in FIG. 6.

FIG. 8 is a structural schematic view showing the structure about the door buckle of the present invention.

FIG. 9 is a partial enlarged view of part B in FIG. 8.

FIG. 10 shows the operation of the opening door and operation of the door buckle of the present invention.

FIG. 11 is an exploded perspective view of the heating box of the present invention.

FIG. 12 is a structural: cross sectional view about the heating tube of the present invention.

FIG. 13 is an assembled view of the heating box of the present invention.

FIG. 14 shows the use of the present invention.

FIG. 15 shows another use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

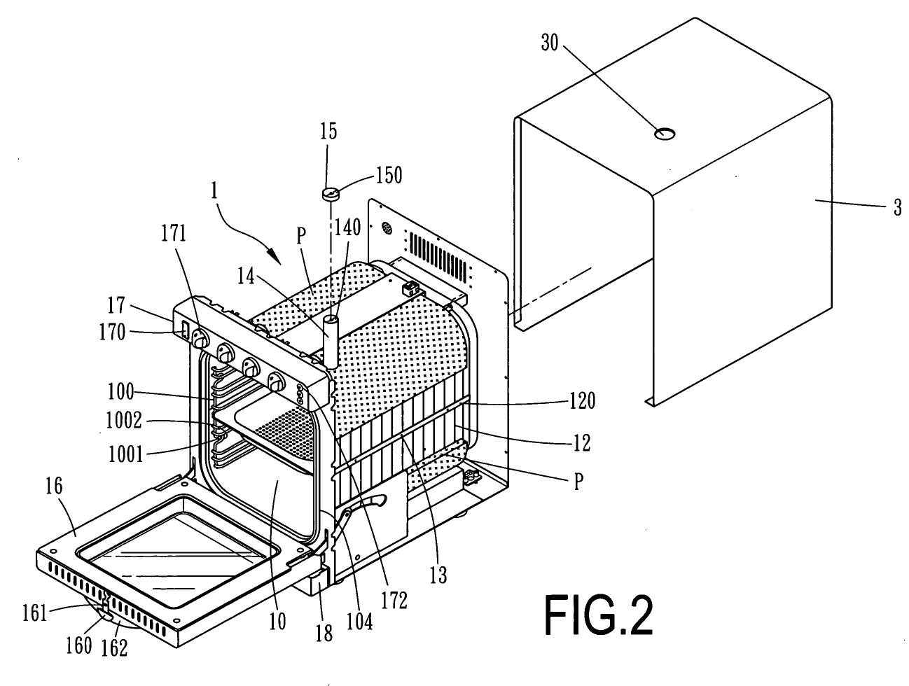

Referring to FIGS. 2, 11 and 12, the present invention includes an oven body 1, a heating box 2, and a casing 3.

The oven body 1 has a receiving chamber 10, a heating tube 11, a heating stripe 12, a positioning unit 13, a chimney 14, a chimney cover 15, a door 16, a control panel 17, and a water box 18.

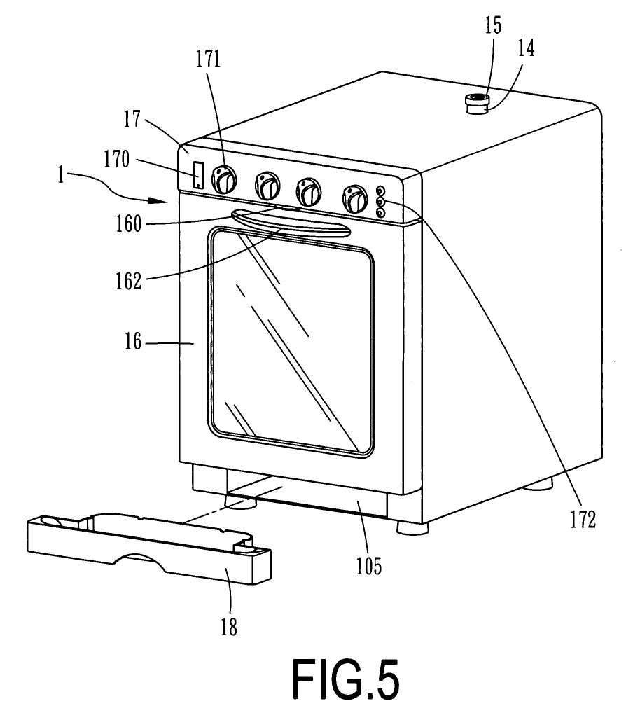

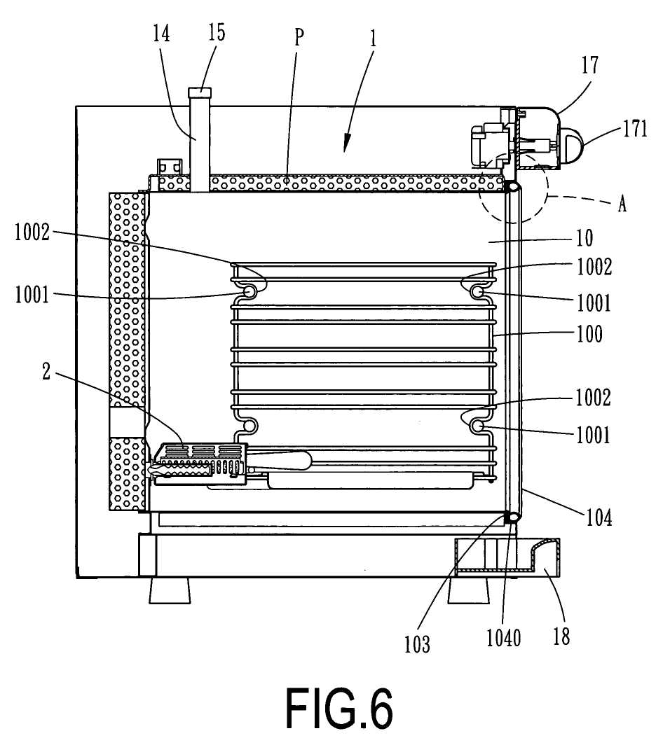

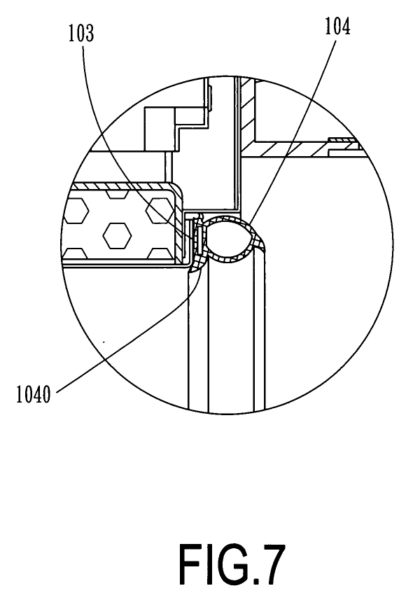

The receiving chamber 10 serves for receiving objects to be baked. The door 16 is closeable for closing the receiving chamber 10 to be as a sealing chamber. The baking is performed by electric heating. The two lateral inner walls of the receiving chamber 10 are installed with symmetric receiving frames 100 and plurality of buckles 1001 which may be screws. The receiving frame 100 is made of metals or steel stripes which are elastic. The receiving frame 100 is installed with buckling grooves 1002 for positioning the buckles 1001 so that the receiving frame 100 can be attached or detached easily. The baking frame or net can be supported in the receiving frame 100. Near a lower side of a rear wall of the receiving chamber 10 has two supporting frames 101 and one supporting plate 102. The two supporting frames 101 are fixed to and extended forwards from the supporting plate 102. The supporting plate 102 is fixed to the rear wall of the receiving chamber 10. An inner wall of a front end of the receiving chamber 10 of the oven body 1 has an embedding recess 103 and a drain proof stripe 104 which are fixed to the embedding recess 103 (referring to FIG. 6). Preferably, the drain proof stripe 104 is formed of silicon gel which is temperature tolerant and low chemical reactivity (referring to FIGS. 6 and 7). One side of the drain proof stripe 104 has an embedding stripe 1040 for embedding into the embedding recess 103. Thus, the drain proof stripe 104 is fixed to a front end of the receiving chamber 10. The drain proof stripe 104 may be a hollow stripe. When the door is closed, the drain proof stripe 104 will compress and deform so as to seal the oven body 1 effectively. A front bottom end of the oven body 1 has a trench 105 (see FIG. 5).

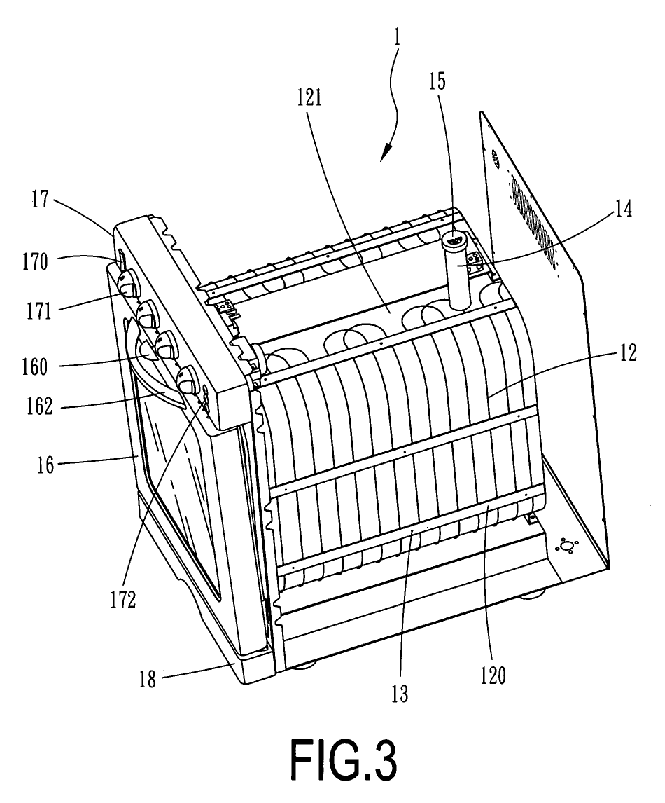

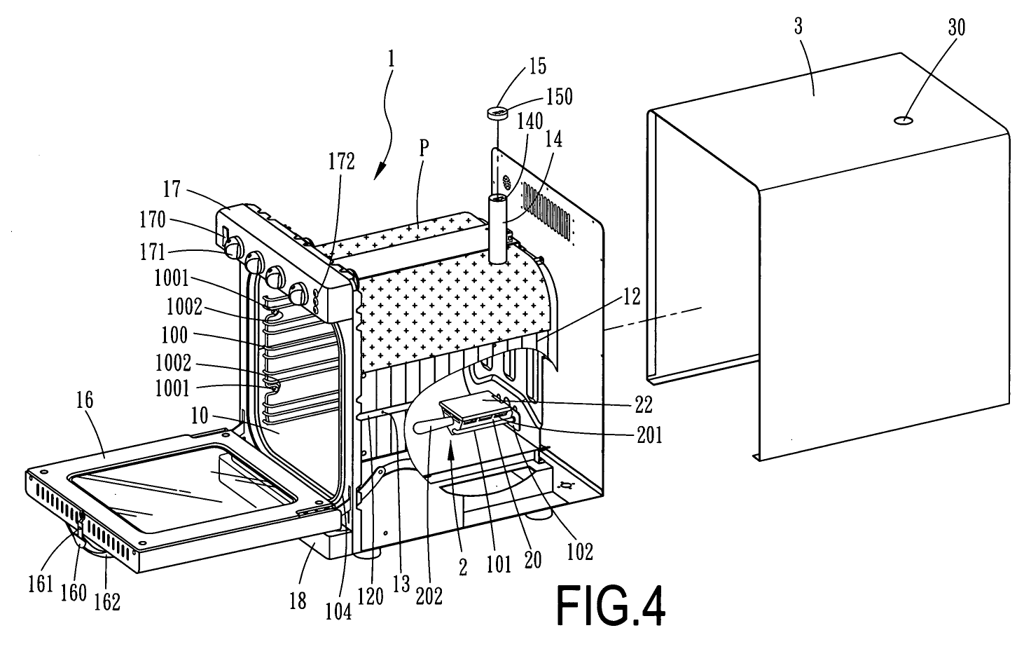

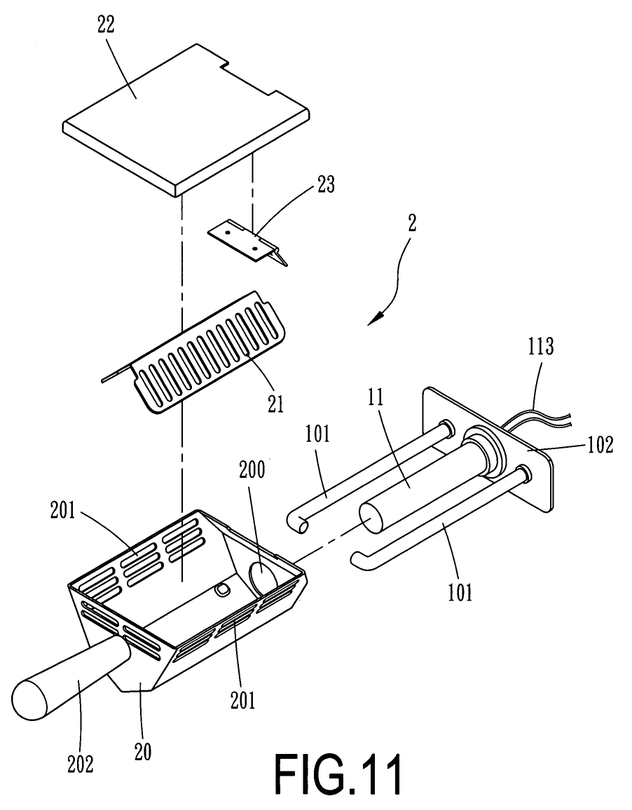

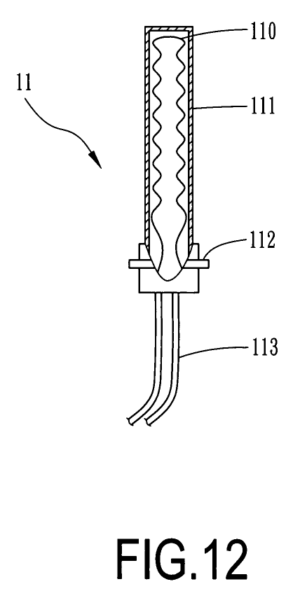

The heating tube 11 passes through the supporting plate 102 and are located between the two supporting frames 101 (referring to FIGS. 4 and 11). The heating tube 11 is a single straight tube (referring to FIG. 12). An interior of the heating tube 11 is installed with heating wire 110 and an exterior thereof is installed with a metal housing 111. A rear end of the heating tube 11 is installed with a fixing frame 112 for retaining the supporting plate 102 at the rear wall of the receiving chamber 10 of the oven body 1. Besides, a rear end of the fixing frame 112 is installed with a power wire 113 for inputting or outputting electric power. Thus the space of the receiving chamber 10 is saved so that thermal power can be used effectively. A plurality of heating stripes 12 are arranged around the oven body 1. The heating stripes 12 are clamps and thus fixed by insulation units 120. A plurality of positioning units 13 (such as rivets) are used to combine the insulation units 120. The insulation units 120 are made of such as Mica or other insulation materials. The heating stripes 12 are arranged around the sides of the oven body 1 (at least enclosing the left, right and bottom of the oven body 1). An insulating paper 121 is placed between the heating stripes 12 and the oven body 1. The insulating paper 121 may be such as an Mica paper), referring to FIG. 3, so as to enhance the insulation of the oven body 1. A layer of temperature tolerant cotton P encloses the heating stripes 12 for preventing heat of the heating stripes 12 from dissipation (referring to FIGS. 2 and 4).

A chimney 14 protrudes from a top of the oven body 1 which penetrates the oven body 1 to the receiving chamber 10. A top of the chimney 14 has a semi-round through hole 140. A chimney cover 15 covers upon the chimney 14. The chimney cover 15 is installed with a semi-round via hole 150 which is corresponding to the through hole 140 of the top of the chimney 14 (referring to FIGS. 2 to 4).

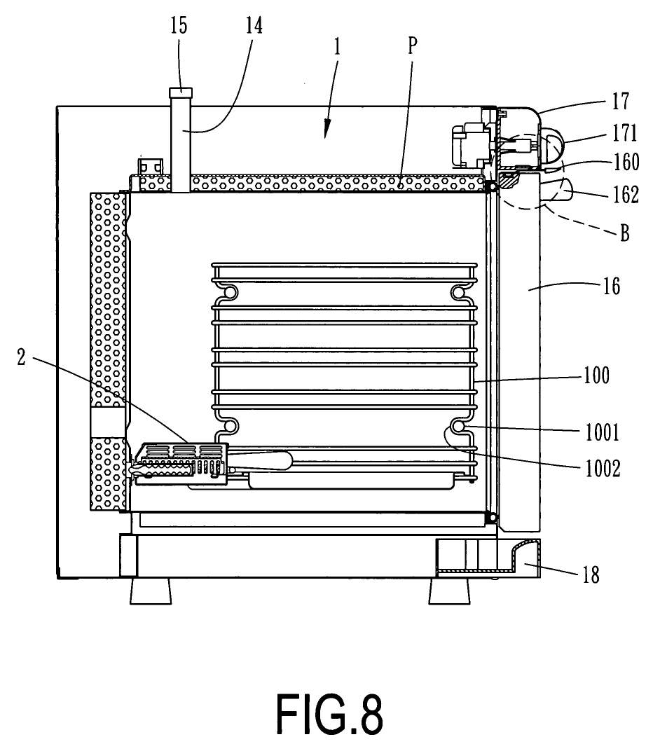

A door 16 is pivotally installed at a front surface of the oven body (referring to FIGS. 8 to 10). An elastic door buckle 160 made of steel sheet is fixed upon the door 16. The door buckle 160 has a protruded stop 161. The door 16 is installed with a handle 162.

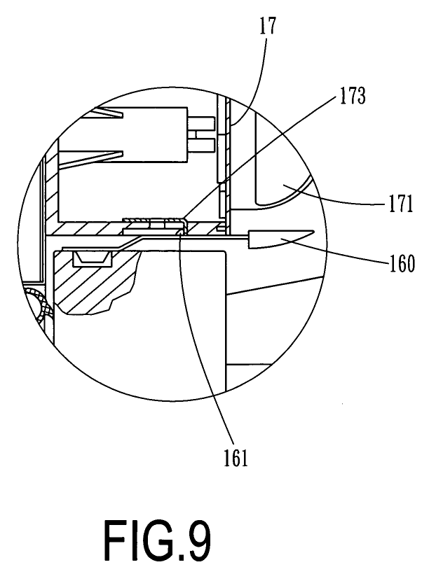

A control panel 17 is installed upon an upper front side of the oven body 1 corresponding to the door 16 (referring to FIG. 2). A control panel 17 has installed with a switch 170, a button 171, and an indication light 172. A bottom of the control panel 17 corresponding to the door buckle 160 is installed with a buckling recess 173 (referring to FIG. 9) for buckling the stop 161 of the door buckle 160 so as to tightly close the door 16. When the door buckle 160 is pressed downwards, the door can be released for operation.

A drawer type water box 18 (referring to FIG. 5) is installed at a lower side of the door 16. The water box 18 can be inserted into the trench 105 at the lower side of the oven body 1. The water box 18 serves for condensing the water draining out from the door 16. The water box 18 can be drawn out for cleaning.

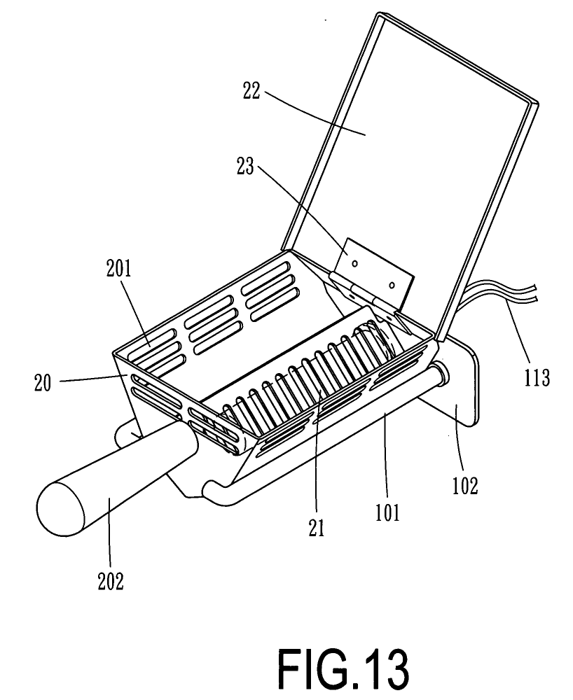

A heating box 2 (referring to FIGS. 4, and 11 to 13) is installed on the supporting frames 101 in the receiving chamber 10 of the oven body 1. The heating box 2 has the following elements.

A box body 20 has a tapered bottom. A rear side of the box body 20 has a through hole 200 for receiving the heating tube 11. The box body 20 is installed with a plurality of vent holes 201. A front side of the box body 20 is protruded with a handle 202. A net 21 is installed in the box body 20. A size of the net 21 is smaller than an upper portion of the box body 20 and smaller than a lower side of the box body 20 so that the net 21 can be positioned at a middle section of the box body 20. A net 21 can support smoking woods. A box cover 22 is pivoted to the box body 20 through a hinge 23. One side of the hinge 23 is firmly secured to the side of the box body 20 having the through hole 200. Another side of the hinge 23 is combined with the box cover 22 so that when the cover 22 covers upon the box body 20, the cover 22 is pivoted with respect to the box.

The casing 3 has an approximate U shape for covering upon the oven body 1 (referring to FIGS. 2 and 4) for enclosing the oven body 1. A top of the casing 3 has a pass hole 30. The chimney 14 protrudes out from the pass hole 30.

In assembly, referring to FIGS. 2, 4 to 8, 11 and 13, firstly, the buckling groove 1002 of the receiving frame 100 is buckled to the buckle 1001 of the receiving chamber 10. Then the receiving frame 100 is pushed backwards to adhere to one lateral wall of the receiving chamber 10 so at the buckling groove 1002 is aligned to the buckle 1001 of the receiving chamber 10. Then the receiving frame 100 is released. The resilient elasticity of the receiving frame 100 will cause the buckling groove 1002 is fixed to the buckle 1001. Thus the object to be baked or baking net can be installed on the receiving frame 100. Then one side of the hinge 23 is firmly secured to the side of the box body 20 having the through hole 200. Another side of the hinge 23 is combined with the box cover 22 so that when the cover 22 covers upon the box body 20, the cover 22 is pivoted with respect to the box. Then the water box 18 is inserted into a bottom of the oven body 1.

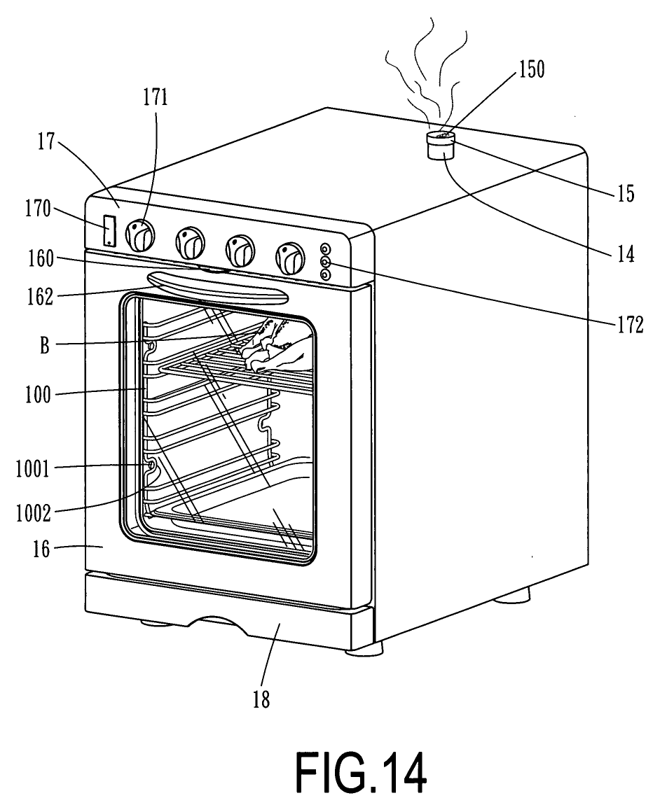

In operation, referring to FIGS. 4, 8 to 10, 13 to 15, at first, the cover 22 is rotated from the box body 20, and the net 21 is placed into the box body 20. Then woods A are placed upon the net 21. Then the cover 22 covers upon the box body 20. Then the hand of user holds the handle 202 so as to place the heating box 2 to the receiving frame 100. Then the heating tube 11 passes through the through hole 200 of the box body 20 and protrudes to the lower side of the net 21. Then a baking disk (or a baking net or a baking frame) with object to be baked is placed upon the receiving frame 100. The door 16 is closed. The stop 161 is buckled into the buckle groove 173 of the control panel 17. Then the temperature and time for baking are set from the control panel 17.

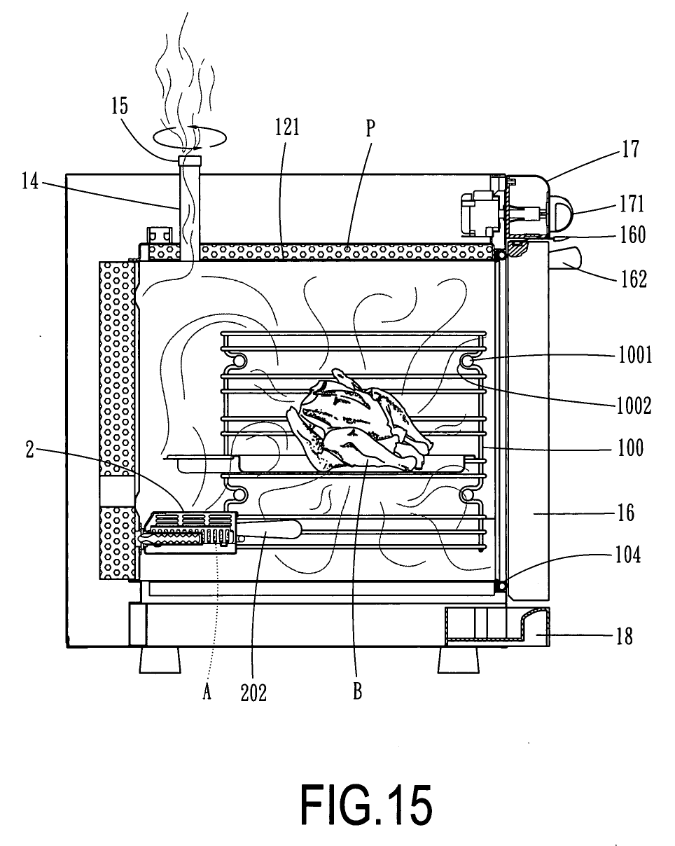

The present invention has two independent heating systems. One is the heating stripes 12 which heat the oven body 1 and thus heat the baking object in the receiving chamber 10. The other is the heating tube 11 in the receiving chamber 10 of the oven body 1. The heating tube 11 heats the woods in the box body 20. The heat is transferred from the vent holes 201 to the whole receiving chamber 10 so as to heat the baked object. The smoke is drained out from the chimney 14 (referring to FIG. 15). When it is desired to vent smoke out of the receiving chamber 10, the via hole 150 of the chimney cover 15 is rotated to align the through hole 140 of the chimney 14. If not used, the via hole 150 is rotated to the top of the chimney 14 to prevent undesired object to fall into the chimney 14. Thereby the object B to be baked presents the color and odors due to the effect of smoke.

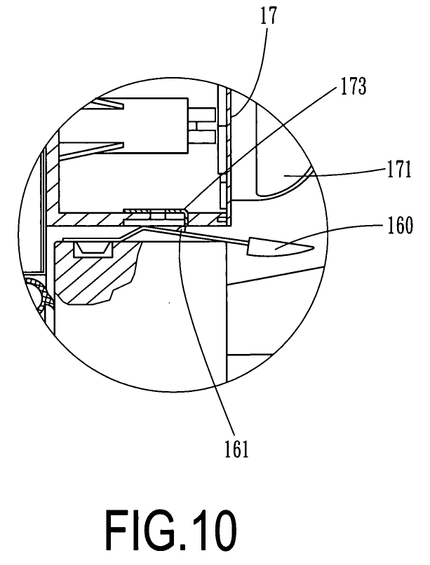

After baking, the door 16 is opened for taking out the object B. Firstly, the door buckle 160 is pressed downwards (referring to FIG. 10) so that the stop 161 on the door buckle 160 separates from the buckling groove 173 of the control panel 17. Then the hand holds the handle 162 of the door 16 for opening the door 16 fully and thus taking out the object B.

Furthermore, in baking, the vapor from the object B is condensed to the water box 18 as the door 16 is opened and water flows out.

Advantages of the present invention will be described herein.

1. Two heat sources, heating stripes 12 and heating tube 11, are used to have dual effect in baking.

2. The temperature tolerant cotton P encloses the heating stripes 12 so that heat can be transferred to the receiving chamber 10 effectively. The heat can be transferred to the receiving chamber 10 uniformly. However the conventional electric heating tubes can not heat an object uniformly. In the heating tubes, those near the tube is heated effectively, while those far away from the tubes are heated ineffectively so that the object to be baked can not be heated uniformly.

3. The heating tube 11 is installed in the heating box 2. The heating box 2 is located at a lower side of the receiving chamber 10 of the oven body 1 so that the space is saved and it can provide an effective heating effect.

4. The present invention can be assembled conveniently. The buckling groove 1002 of the receiving frame 100 is buckled to the buckle 1001 of the receiving chamber 10. Then the receiving frame 100 is pushed backwards to adhere to one lateral wall of the receiving chamber 10 so at the buckling groove 1002 is aligned to the buckle 1001 of the receiving chamber 10. Then the receiving frame 100 is released. The resilient elasticity of the receiving frame 100 will cause the buckling groove 1002 is fixed to the buckle 1001. The receiving frame 100 can be taken out easily for cleaning.

5. In the present invention, the drain proof stripe 104 made of silica gel is installed in front of the receiving chamber 10 of the oven body 1 and will make the door tightly seal upon the receiving chamber 10. Thus in heating, the smoke will not drain out so as to increase the heating efficiency.

6. In the present invention, a plurality of heating stripes 12 are arranged around the oven body 1. The heating stripes 12 are clamps and thus fixed by insulation units 120. Thus positioning units 13 (such as rivets) are used to combine the insulation units 120. The insulation units 120 are made of such as Mica or other insulation materials. The heating stripes 12 are arranged around the sides of the oven body 1 (at least enclosing the left, right and bottom of the oven body 1). An insulating paper 121 is placed between the heating stripes 12 and the oven body 1. The insulating paper 121 may be such as Mica paper), referring to FIG. 3 so as to enhance the insulation of the oven body 1. A layer of temperature tolerant cotton P encloses the heating stripes 12 for preventing heat of the heating stripes 12 from dissipation (referring to FIGS. 2 and 4). The Mica is a good insulating material which is a large resistance, lower dielectric lose, and is anti-electric arc, etc.

7. In the present invention, the chimney 14 protrudes from the top of the oven body 1 which penetrates the oven body 1 to the receiving chamber 10. The top of the chimney 14 has the semi-round through hole 140. The chimney cover 15 covers upon the chimney 14. The chimney cover 15 is installed with the semi-round via hole 150 which is corresponding to the through hole 140 of the top of the chimney 14. When it is desired to vent smoke out of the receiving chamber 10, the via hole 150 of the chimney cover 15 is rotated to align the through hole 140 of the chimney 14. If not used, the via hole 150 is rotated to the top of the chimney 14 to prevent undesired object to fall into the chimney 14). Thereby the object B to be baked presents the color and odors due to the effect of smoke. Furthermore, the chimney cover 15 can be covered upon the chimney partially so as to adjust the baking color of the baked object.

8. In the present invention, the door 16 is pivotally installed at the front surface of the oven body. An elastic door buckle 160 made of steel sheet is fixed upon the door 16. The door buckle 160 has the protruded stop 161. The door 16 is installed with the handle 162. The control panel 17 is installed upon an upper front side of the oven body 1 corresponding to the door 16. The bottom of the control panel 17 corresponding to the door buckle 160 is installed with the buckling recess 173 for buckling the stop 161 of the door buckle 160 so as to tightly close the door 16. When the door buckle 160 is pressed downwards, the door can be released for operation. After baking, the door 16 is opened for taking out the object B. Firstly, the door buckle 160 is pressed downwards (referring to FIG. 10) so that the stop 161 on the door buckle 160 separates from the buckling groove 173 of the control panel 17. Then the hand holds the handle 162 of the door 16 for opening the door 16 fully and thus taking out the object B.

9. In the present invention, the control panel 17 has installed with the switch 170, the button 171, and an indication light 172. The user can adjust the baking temperature and time from the control panel and view the operation states from the window on the door 16.

10. In the present invention, the drawer type water box 18 is installed at the lower side of the door 16. The water box 18 can be inserted into the trench 105 at the lower side of the ‘oven body 1. The water box 18 serves for condensing the water draining out from the door 16. The water box 18 can be drawn out for cleaning. Furthermore, in baking, the vapor from the object B is condensed to the water box 18 as the door 16 is opened with flowing out to outside.

11. In the present invention, the box body 20 has the tapered bottom. The rear side of the box body 20 has the through hole 200 for receiving the heating tube 11. The box body 20 is installed with the plurality of vent holes 201. The front side of the box body 20 is protruded with the handle 202. The net 21 is installed in the box body 20. The size of the net 21 is smaller than an upper portion of the box body 20 and smaller than the lower side of the box body 20 so that the net 21 can be positioned at the middle section of the box body 20. The net 21 can support smoking woods. The box cover 22 is pivoted to the box body 20 through the hinge 23. One side of the hinge 23 is firmly secured to the side of the box body 20 having the through hole 200. Another side of the hinge 23 is combined with the box cover 22 so that when the cover 22 covers upon the box body 20, the cover 22 is pivoted with respect to the box.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A smoke and electric heating oven, comprising:
an oven body installed with a receiving chamber; a receiving frame being installed therein, a supporting frame being installed below the receiving frame; the supporting frame being installed with a heating tube; an outer side of the oven body being enclosed by heating stripes; a top of the oven body being protruded with a chimney which penetrates to the receiving chamber; a front side of the oven body being installed with a door; a front edge of the oven body having a control panel;
a heating box installed on the supporting frame in the oven body; the heating tube being inserted into the heating box; and
a casing enclosing an outer side of the oven body and heating stripes; a top of the casing having a pass hole; and the chimney passing through the pass hole.

2. The smoke and electric heating oven as claimed in claim 1, wherein two inner wall of the receiving chamber are installed with respective buckles.

3. The smoke and electric heating oven as claimed in claim 1, wherein the receiving frame is made of elastic metal strips; and the receiving frame is installed with buckling grooves.

4. The smoke and electric heating oven as claimed in claim 1, wherein a lower side of a rear wall of the receiving frame is installed with at least one supporting plate for supporting the supporting frame.

5. The smoke and electric heating oven as claimed in claim 1, wherein a front side of the receiving chamber is installed with an embedding groove.

6. The smoke and electric heating oven as claimed in claim 1, wherein a front end of the receiving chamber is installed with a drain proof stripe.

7. The smoke and electric heating oven as claimed in claim 6, wherein the drain proof stripe is made of silica gel.

8. The smoke and electric heating oven as claimed in claim 1, wherein an interior of the heating tube is installed with heating wire and an exterior thereof is installed with a metal housing; a rear end of the heating tube is installed with a fixing frame for retaining the supporting plate at the rear wall of the receiving chamber of the oven body; and a rear end of the fixing frame is installed with a power wire for inputting or outputting electric power.

9. The smoke and electric heating oven as claimed in claim 1, wherein the heating stripes are clamps and thus fixed by insulation units; a plurality of positioning units are used to combine the insulation units; and the insulation units are made of Mica.

10. The smoke and electric heating oven as claimed in claim 1, wherein an insulating paper is placed between the heating stripes and the oven body; and the insulating paper is Mica paper.

11. The smoke and electric heating oven as claimed in claim 1, wherein a layer of temperature tolerant cotton encloses the heating stripes for preventing heat of the heating stripes from dissipation.

12. The smoke heating oven as claimed in claim 1, wherein a top of the chimney has a through hole.

13. The smoke and electric heating oven as claimed in claim 1, wherein a top of the chimney is installed with a chimney cover; and the chimney cover is installed with a via hole.

14. The smoke and electric heating oven as claimed in claim 1, wherein an upper side of the door has a door buckle; and a stop protrudes from the door buckle; and the door buckle is made of elastic material.

15. The smoke and electric heating oven as claimed in claim 1, wherein the door has a handle.

16. The smoke and electric heating oven as claimed in claim 1, wherein the control panel is installed with a switch, a button and an indication light and a bottom of the control panel is installed with a buckling groove.

17. The smoke and electric heating oven as claimed in claim 1, wherein a drawer type water box is installed at a lower side of the door and a lower side of the door has a door buckle.

18. The smoke and electric heating oven as claimed in claim 1, wherein a heating box is installed on the supporting frames in the receiving chamber of the oven body; a box body of the heating box is formed with a plurality of vent holes; and a net is installed in the box body for receiving woods.

19. The smoke and electric heating oven as claimed in claim 1, wherein a rear side of the box body has a through hole for receiving the heating tube; a front end of the box body has a handle; and a cover covers upon the box body.
